(19) United States
(12) Patent Application Publication
(10) Pub. No.: US 2009/0244668 A1
(43) Pub. Date: Oct. 1, 2009

(54) METHOD OF DRIVING MEMS MIRROR SCANNER, METHOD OF DRIVING MEMS ACTUATOR SCANNER AND METHOD OF CONTROLLING ROTATION ANGLE OF MEMS ACTUATOR

(75) Inventors: Makoto FUJINO, Itabashi-ku (JP); Yoshiaki GOTO, Itabashi-ku (JP); Michiko NAKANISHI, Itabashi-ku (JP); Hirotake MARUYAMA, Itabashi-ku (JP); Akio KOBAYASHI, Itabashi-ku (JP); Hirokazu TAMURA, Itabashi-ku (JP)

Correspondence Address: BUCHANAN, INGERSOLL & ROONEY PC, POST OFFICE BOX 1404, ALEXANDRIA, VA, 22313-1404, US

(73) Assignee: Kabushiki Kaisha TOPCON, Itabashi-ku (JP)

(21) Appl. No.: 12/414,921

(22) Filed: Mar. 31, 2009

(30) Foreign Application Priority Data
Apr. 1, 2008 (JP) 2008-094587
Dec. 24, 2008 (JP) 2008-326960

(51) Int. Cl. G02B 26/10

(52) U.S. Cl. 359/200.6

(57) ABSTRACT

A method of driving a MEMS mirror scanner having an electrostatic actuator, comprising a step of driving the electrostatic actuator according to an input signal in accordance with a driving waveform obtained by the following equation,

$$when$$

$${C}_{+}^{′} ( θ ) \neq 0$$

$${V}_{V} ( t ) = \frac{1}{\frac{{C}_{+}^{′} ( θ )}{I}} [ \begin{matrix}- \frac{{C}_{-}^{′} ( θ )}{I} {V}_{B} + \\ \sqrt{\begin{matrix}- ( \frac{1}{I} \frac{d {C}_{L} ( θ )}{d θ} ) ( \frac{1}{I} \frac{d {C}_{R} ( θ )}{d θ} ) {V}_{B}^{2} + \\ \frac{{C}_{+}^{′} ( θ )}{I} ( \ddot{θ} + 2 \frac{B}{I} \dot{θ} + \frac{κ}{I} θ )\end{matrix}}\end{matrix} ]$$

$$when$$

$${C}_{+}^{′} ( θ ) = 0$$

$${V}_{V} ( t ) = \frac{\ddot{θ} + 2 \frac{B}{I} \dot{θ} + \frac{κ}{I} θ}{2 \frac{{C}_{-}^{′} ( θ )}{I} {V}_{B}}$$

where, B/I, κ/I, (1/I)·dC_{L}(θ)/dθ and (1/I)·dC_{R}(θ)/dθ are parameters for obtaining the driving waveform, θ(t) is a desired mirror angle response, I is a moment of inertia of a moving part including a mirror, 2B is a damping factor (damping coefficient), κ is a spring constant, C_{L}(θ) and C_{R}(θ) are angle dependencies of an electric capacitance, V_{B} is a constant bias voltage in differential driving, and C₊′(θ) and C₋′(θ) are ½ of the sum and the difference of the first order derivative of C_{L}(θ) and C_{R}(θ) with respect to θ, respectively, which are represented by defined equations.

### PRIORITY CLAIM

The present application is based on and claims priorities from Japanese Patent Application No. 2008-094587, filed on Apr. 1, 2008, and Japanese Patent Application No. 2008-326960, filed on Dec. 24, 2008, the disclosures of which are hereby incorporated by reference in their entirety.

### BACKGROUND OF THE INVENTION

1. Field of the Invention

The present invention relates to micro-electro-mechanical systems (MEMS), in particular, to a method of driving a MEMS mirror scanner, a method of driving a MEMS actuator scanner, and a method of controlling a rotation angle of a MEMS actuator, a MEMS micro-scanner for use, for example, in an optical deflector for obtaining and displaying an image, reducing a sensing error by diffusion of light, and sensing by scanning light, and a method of controlling such a MEMS micro-scanner.

2. Description of the Related Art

Recently, with an increase in a speed and functions of optical devices, high-speed switching of an optical path and vector drawing of a desired pattern have been required. For example, in a lightwave range finder, in order to compensate a measurement error, an inside optical path disposed inside the device and an outside optical path for measuring a distance from the device to an outside target are switched, and the optical distances are alternately measured. With an increase in a speed and functions of the device, high-speed switching of the optical paths is required.

A technique described in a light controller for a ranging device (Japanese Patent Application No. 2006-294219) requires high-speed switching of an optical path for controlling attenuation of light at a high speed. When capturing a measurement target by a lightwave range finder, a light beam has to be projected at a predefined angle at a high speed. In this case, high-speed switching of the optical path is required. In a device for displaying a line image by means of laser beam scanning, it is required to perform optical scanning corresponding to a desired pattern to be drawn.

A MEMS mirror scanner (MEMS actuator scanner) is often used for the high-speed switching of an optical path and the vector drawing of a desired pattern. Due to a small size, the MEMS mirror scanner has advantages in high speed and low power consumption.

FIG. 1 is a view illustrating one example of a MEMS mirror scanner. In FIG. 1, reference number 101 denotes a planar mirror, 102 denotes a torsion spring, 103 denotes a fixed portion, 104 denotes an incident light beam, and 105 denotes a reflected and deflected beam. It is necessary for the MEMS mirror scanner to have a desired temporal property from a time when a driving factor such as, for example, voltage is input to a time when the mirror or the MEMS actuator is stopped at a desired angle.

In the MEMS mirror scanner illustrated in FIG. 1, if it is possible to spend a sufficient time for driving, quasi-static driving of the MEMS mirror scanner is employed. In this case, if the relationship between a driving factor such as voltage and the rotation angle is known, desired driving can be performed. For example, when changing an angle from θ_{A} to θ_{B} in quasi-static driving which spends a sufficient time, an angle response curve with respect to time becomes a monotonous curve 106 as illustrated by the dashed line in FIG. 2.

However, such driving requires a time long enough to be able to ignore effects of the inertia and damping, and a part of the advantages in using a MEMS mirror scanner is lost.

On the other hand, if driving time is simply reduced, an unintended mirror angle response results from effects of the inertia and damping, which are dynamic features. For example, if one tries to change the angle of the mirror 101 from θ_{A} to θ_{B} in a reduced driving time by applying a step-like voltage, transient oscillation (ringing) is caused as illustrated in FIG. 2. The angle response curve with respect to time becomes an oscillating curve 107 which requires a relatively long time to stabilize.

Accordingly, driving techniques taking account of the inertia and damping, which are dynamic features of a MEMS mirror scanner have been proposed (refer to the following non-patent documents 1-6).

Non-patent document 1: V. Milanovic, K. Castelino, “Sub-100 μs Settling Time and Low Voltage Operation for Gimbal-less Two-Axis Scanners”, IEEE/LEOS Optical MEMS 2004, Takamatsu, Japan, August 2004.

Non-patent document 2: K. Castelino, V. Milanovic, D. T. McCormick, “MEMS-based high-speed low-power vector display”, 2005 IEEE/LEOS Optical MEMS and Their Applications Conf., Oulu, Finland, August 2005, pp. 127-128.

Non-patent document 3: Y. Sakai, T. Yamabana, S. Ide, K. Mori, A. Ishizuka, O. Tsuboi, T. Matsuyama, Y. Ishii, M. Kawai, “Nonlinear Torque Compensation of Comb-Driven Micromirror”, Optical MEMS 2003, TuP16.

Non-patent document 4: M. Kawai, “Research and Development of Photonic Network using Optical Burst-Switching” (NICT contract research).

Non-patent document 5: K. Ide, H. Ibe, “A Study if High Speed MEMS Mirror Drive dor Optical Wireless Communication”, Proceedings of Information and Communication Engineers Society Meeting, Vol. 2005 Electronics, No. 1 (20050307) P. 350, (2005).

Non-patent document 6: K. Ide, H. Ibe “A Resonant Compression Method of MEMS Mirror for Optical Wireless Communication”, Proceedings of Information and Communication Engineers Society Meeting, Vol. 2005, Electronics, No. 1 (20050907) P. 333 (2005).

Although the oscillation of a MEMS mirror scanner can be suppressed to some degree by the techniques disclosed in the above documents 1-6, a desired time-angle response feature required by each specific application can not be achieved.

A method of obtaining a time-mirror angle response curve 109 has been considered with a step-like function as an input signal where the function is represented by a time parameter P1 and a voltage parameter P2, as illustrated in Graph A in FIG. 3. A method of suppressing the transient oscillation (ringing) of an angle response curve 109 in changing the angle of the mirror 101 from θ_{A} to θ_{B} has been also considered with a pulse-like function as an input signal with time parameters P1′ and P2′ used as tuning parameters as illustrated in Graph B in FIG. 3.

In the methods illustrated in FIG. 3, a parameter reference table is required, but this reference table includes a large amount of data which requires a large capacity of memory and complicates a driving scheme.

Moreover, it takes a long time to experimentally determine the parameters. If a driving waveform is determined, a time dependency pattern of the mirror angle (mirror angle response) and the stabilization time is defined, which lowers the degree of freedom in driving. Furthermore, although in the case of the driving waveform illustrated in FIG. 3, the driving waveform has a simple shape, which seems to be easily generated, error tolerance of the waveform for controlling the transient oscillation (ringing) becomes extremely stringent.

### SUMMARY OF THE INVENTION

It is, therefore, an object of the present invention to provide a method of driving a MEMS mirror scanner and a MEMS actuator scanner and controlling a rotation angle of a MEMS actuator, which accurately damp their oscillation to a resting state, and simplify a scheme of driving without using a large capacity memory, so as to quickly determine parameters and sufficiently ensure the degree of freedom in driving.

In order to achieve the above object, a first aspect of the present invention relates to a method of driving a MEMS mirror scanner including an electrostatic actuator. The method includes a step of driving the electrostatic actuator according to an input signal in accordance with a driving waveform obtained by the following equation.

$$when$$

$${C}_{+}^{′} ( θ ) \neq 0$$

$${V}_{V} ( t ) = \frac{1}{\frac{{C}_{+}^{′} ( θ )}{I}} [ \begin{matrix}- \frac{{C}_{-}^{′} ( θ )}{I} {V}_{B} + \\ \sqrt{\begin{matrix}- ( \frac{1}{I} \frac{d {C}_{L} ( θ )}{d θ} ) ( \frac{1}{I} \frac{d {C}_{R} ( θ )}{d θ} ) {V}_{B}^{2} + \\ \frac{{C}_{+}^{′} ( θ )}{I} ( \ddot{θ} + 2 \frac{B}{I} \dot{θ} + \frac{κ}{I} θ )\end{matrix}}\end{matrix} ]$$

$$when$$

$${C}_{+}^{′} ( θ ) = 0$$

$${V}_{V} ( t ) = \frac{\ddot{θ} + 2 \frac{B}{I} \dot{θ} + \frac{κ}{I} θ}{2 \frac{{C}_{-}^{′} ( θ )}{I} {V}_{B}}$$

Where B/I, κ/I, (1/I)·dC_{L}(θ)/dθ and (1/I)·dC_{R}(θ)/dθ are parameters to obtain the driving waveform, θ(t) is a desired mirror angle response, I is a moment of inertia of a moving part including a mirror, 2B is a damping factor (damping coefficient), κ is a spring constant, C_{L}(θ) and C_{R}(θ) are angle dependencies of an electric capacitance, V_{B} is a constant bias voltage in differential driving, and C₊′(θ) and C₋′(θ) are ½ of the sum and the difference of the first order derivative of C_{L}(θ) and C_{R}(θ) with respect to θ, respectively, which are represented by the following equations.

$$\begin{matrix}{C}_{+}^{′} ( θ ) = \frac{1}{2} ( \frac{d {C}_{L} ( θ )}{d θ} + \frac{d {C}_{R} ( θ )}{d θ} ) , & ( 8 ) \\ {C}_{-}^{′} ( θ ) = \frac{1}{2} ( - \frac{d {C}_{L} ( θ )}{d θ} + \frac{d {C}_{R} ( θ )}{d θ} ) & ( 9 )\end{matrix}$$

A second aspect of the present invention relates to a method of driving a MEMS mirror scanner including an electrostatic actuator. The method includes a step of driving the electrostatic actuator according to an input signal in accordance with a driving waveform obtained by the following equation.

$${V}_{V} ( t ) = \sqrt{\frac{\ddot{θ} + 2 \frac{B}{I} \dot{θ} + \frac{κ}{I} θ - \frac{1}{2} \frac{1}{I} \frac{d {C}_{L} ( θ )}{d θ} {V}_{B} ( t )}{\frac{1}{2} \frac{1}{I} \frac{d {C}_{R} ( θ )}{d θ}}}$$

where B/I, κ/I, (1/I)·dC_{L}(θ)/dθ and (1/I)·dC_{R}(θ)/dθ are parameters for obtaining the driving waveform, θ(t) is a desired mirror angle response, I is a moment of inertia of a moving part including a mirror, 2B is a damping factor (damping coefficient), κ is a spring constant, C_{L}(θ) and C_{R}(θ) are angle dependencies of an electric capacitance, V_{B}(t) is a constant bias voltage or an appropriately determined time-dependent voltage change in single side driving, and C₊′(θ) and C₋′(θ) are ½ of the sum and the difference of the first order derivative of C_{L}(θ) and C_{R}(θ) with respect to θ, respectively, which are represented by the following equations.

$$\begin{matrix}{C}_{+}^{′} ( θ ) = \frac{1}{2} ( \frac{d {C}_{L} ( θ )}{d θ} + \frac{d {C}_{R} ( θ )}{d θ} ) , & ( 8 ) \\ {C}_{-}^{′} ( θ ) = \frac{1}{2} ( - \frac{d {C}_{L} ( θ )}{d θ} + \frac{d {C}_{R} ( θ )}{d θ} ) & ( 9 )\end{matrix}$$

Preferably, at least one of the parameters is experimentally determined.

Preferably, θ(t) is two times differentiable with respect to time.

A third aspect of the present invention relates to a method of driving a MEMS actuator scanner, including steps of: defining an actuation of the MEMS actuator as a function of time; determining by an experiment or calculation terms included in the equation of motion governing motion of the MEMS actuator except a variable representing the actuation, derivatives thereof with respect to time and a variable corresponding to an input signal; and determining the input signal by substituting to the equation of motion the actuation of the MEMS actuator as the function of time and the terms in the equation of motion except the variable representing the actuation, the derivatives thereof with respect to time and the variable corresponding to the input signal.

Preferably, the variable representing the actuation is two times differentiable with respect to time.

Preferably, the MEMS actuator scanner includes an electrostatically-driven comb structure, the variable representing the actuation in the equation of motion governing motion of the MEMS actuator is a displacement or a rotation angle, the variable corresponding to the input signal is voltage, the terms in the equation of motion governing motion of the MEMS actuator except the variable representing the actuation, the derivatives thereof with respect to time and the variable corresponding to the input signal are an inertia term, a damping term, an elastic term and a first order derivative of the electric capacitance of the comb structure with respect to the displacement or the rotation angle.

Preferably, the damping term is determined by measuring a transient damping oscillation around a state where applied voltage to the MEMS actuator is 0.

Preferably, the elastic term is determined by measuring a transient damping oscillation around a state where applied voltage to the MEMS actuator is 0.

Preferably, the damping term is determined by measuring a resonance characteristic of the MEMS actuator.

Preferably, the elastic term is determined by measuring a resonance characteristic of the MEMS actuator.

Preferably, the first order derivative of the electric capacitance of the comb structure with respect to the displacement or the rotation angle is determined by measuring a relationship between quasi-statically applied voltage and the displacement or the rotation angle of the actuator.

A fourth aspect of the present invention relates to a method of controlling a rotation angle of a MEMS actuator having an angled comb structure, which is driven by voltage, comprising steps of: defining the rotation angle of the MEMS actuator as a function of time; determining by an experiment or calculation terms included in the equation of motion governing the rotation except the rotation angle, derivatives thereof with respect to time and the voltage and determining the voltage by substituting to the equation of motion the rotation angle and the terms in the equation of motion except the rotation angle, the derivatives thereof with respect to time and the voltage.

Preferably, the rotation angle of the MEMS actuator is two times differentiable with respect to time.

Preferably, the terms in the equation of motion governing the rotation of the MEMS actuator except the rotation angle, the derivatives thereof with respect to time and the voltage are an inertia term, a damping term, an elastic term and a first order derivative of an electric capacitance of the comb structure with respect to the rotation angle.

Preferably, the damping term is determined by measuring a transient damping oscillation around a state where applied voltage to the MEMS actuator is 0.

Preferably, the elastic term is determined by measuring a transient damping oscillation around a state where applied voltage to the MEMS actuator is 0.

Preferably, the damping term is determined by measuring a resonance characteristic of the MEMS actuator.

Preferably, the elastic term is determined by measuring a resonance characteristic of the MEMS actuator.

Preferably, the first order derivative of the electric capacitance of the comb structure with respect to the rotation angle is determined by measuring a relationship between quasi-statically applied voltage and the rotation angle of the MEMS actuator.

### BRIEF DESCRIPTION OF THE DRAWINGS

The accompanying drawings are included to provide further understanding of the invention, and are incorporated in and constitute a part of this specification. The drawings illustrate embodiments of the invention and, together with the specification, serve to explain the principle of the invention.

FIG. 1 is a view illustrating a general MEMS mirror scanner.

FIG. 2 is a view illustrating one example of an angle response curve of a MEMS mirror with respect to time.

FIG. 3 is a view illustrating one example of an angle response curve of a MEMS mirror with respect to time, and providing a graph A describing a technique for obtaining an angle response curve of a mirror with respect to time by providing an input signal of a step-function-like waveform and a graph B describing a technique for obtaining an angle response curve of a mirror with respect to time by providing an input signal of a pulse-function-like waveform.

FIG. 4 is a view illustrating a mirror scanner having an angled comb electrostatic actuator according to one embodiment of the present invention.

FIG. 5 is a view illustrating an angle dependency of an electrostatic capacitance of the electrostatic actuator illustrated in FIG. 4.

FIG. 6 is a view illustrating derivatives (dC_{L}/dθ+dC_{R}/dθ)/2, (−dC_{L}/dθ+dC_{R}/dθ)/2, dC_{L}/dθ and dC_{R}/dθ included in equations (8) and (9) as functions of the angle when assuming the angle dependency of the electrostatic capacitance illustrated in FIG. 5.

FIG. 7 is a view illustrating one example of a measurement device pertaining to the present invention.

FIG. 8 is a view illustrating another example of a measurement device pertaining to the present invention.

FIG. 9 is a view describing an experimentally observed oscillating curve of an angle response with respect to time, and providing Part A illustrating an oscillating curve and Part B showing a waveform of the oscillating curve actually displayed on an oscilloscope.

FIG. 10 is a view illustrating a resonance characteristic obtained by an experiment.

FIG. 11 is a view illustrating an applied voltage-angle curve used for determining parameters (1/I)·dC_{L}(θ)/dθ and (1/I)·dC_{R}(θ)/dθ.

FIG. 12 is a block diagram illustrating one example of a driving circuit used to experimentally determine parameters B/I and B/I=1/tD.

FIG. 13 is a block diagram illustrating another example of a driving circuit used to experimentally determine parameters B/I and B/I=1/tD.

FIG. 14 is a block diagram illustrating yet another example of a driving circuit used to experimentally determine parameters B/I and B/I=1/tD.

FIG. 15 is a view illustrating one example of a composition of a microprocessor unit.

FIG. 16 is a view illustrating a mirror scanner having a staggered vertical comb electrostatic actuator pertaining to the present invention.

FIG. 17 is a view describing a relationship between an angle response characteristic and an input to obtain the angle response characteristic, and providing Graph A illustrating a desired angle response characteristic and Graph B illustrating an ideal input to obtain the desired angle response characteristic.

### DETAILED DESCRIPTION OF THE PREFERRED EMBODIMENT

Hereinafter, a method of controlling a rotation angle of a MEMS mirror scanner, a MEMS actuator scanner and a MEMS actuator will be described with reference to the accompanying drawings.

### Embodiment

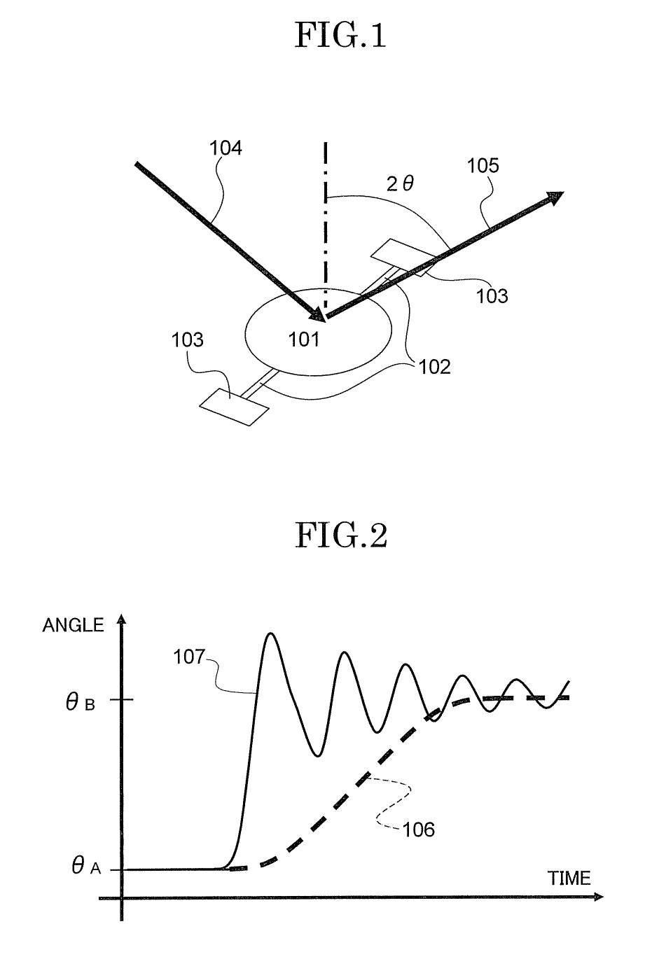

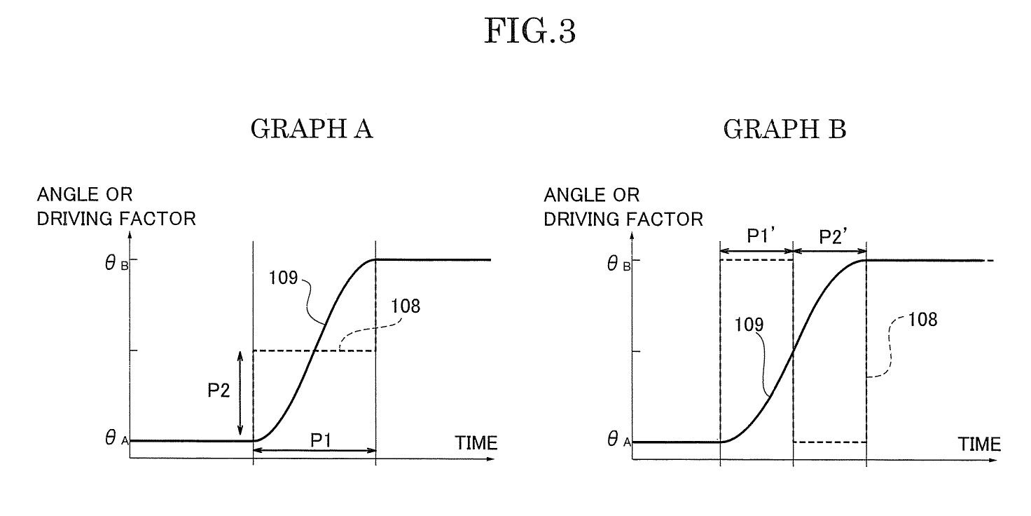

Generally, in the case of the MEMS mirror scanner illustrated in FIG. 1, the equation of motion with respect to the rotation angle θ of a mirror 101 is expressed by the following equation, where I is a moment of inertia of the rotating part including the mirror 101, 2B is a damping factor, κ is a spring constant, and TL and TR are driving torques of the right and left actuators, respectively.

I\ddot{θ}+2B\dot{θ}+κθ=T_{Total}(θ,w) (1)

where \ddot{θ}=d²θ/dt², \dot{θ}=dθ/dt

In this case, the coefficients of the rotation angle, the first order derivative of the rotation angle with respect to time and the second order derivative of the rotation angle with respect to time are denominated an elastic term, a damping term and an inertia term, respectively. When the motion of an actuator is not angular but translational, the coefficients of the displacement, the first order derivative of the displacement with respect to time and the second order derivative of the displacement with respect to time are also denominated an elastic term, a damping term and an inertia term, respectively. Tₜₒₜₐₗ(θ, w) is a sum of the driving torques of the right and left actuators.

In addition, w is a driving factor, which means voltage or current, for example.

If a desired mirror angle response is θ(t), the driving factor w(t) can be obtained according to the equation (1), and an input signal can be applied according to the driving factor w(t).

A method of determining the driving factor w(t) will be described hereinafter.

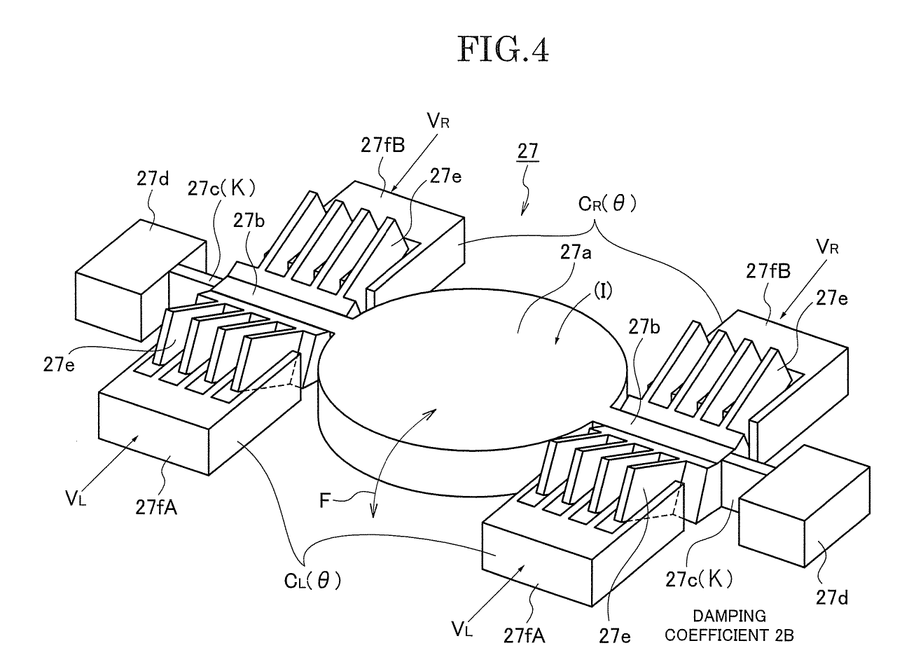

As one example of MEMS mirror scanners (MEMS actuator scanners), an angled comb MEMS electrostatic actuator 27 illustrated in FIG. 4 will be described.

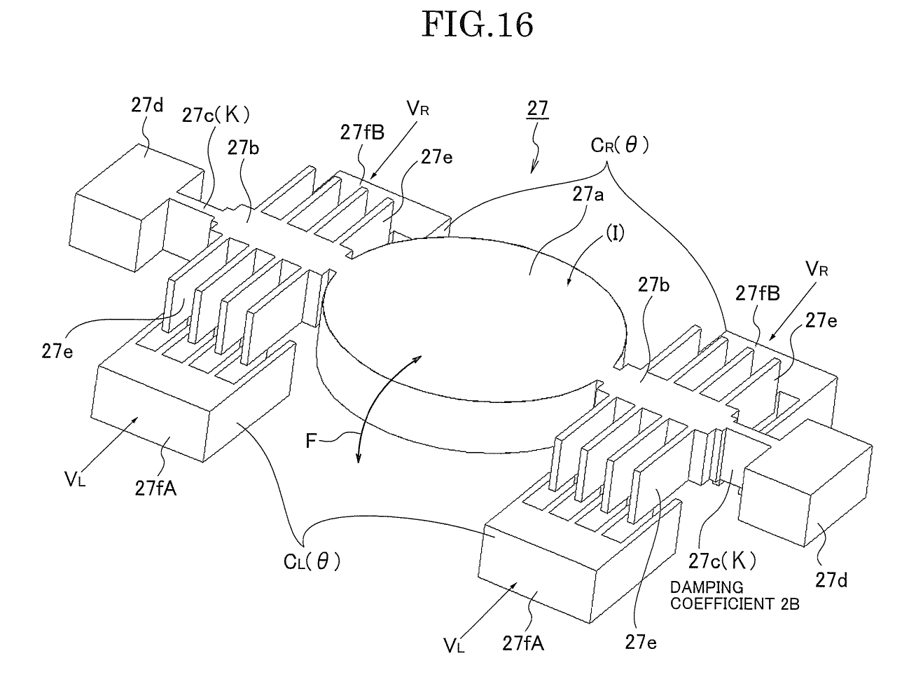

As illustrated in FIG. 4, the angled comb has a structure in which movable combs 27e, 27e and fixed combs 27fA, 27fB are disposed at a predetermined angle. As another structure, there is a staggered vertical comb having a structure in which movable combs 27e, 27e and fixed combs 27fA, 27fB are disposed at a predetermined step as illustrated in FIG. 16. There is also a single side comb having a structure in which a comb is disposed on only one side. The above-described angled comb structure and stepped comb structure can be applied to the single side comb. The present invention can be applied to any type of the comb structures.

The MEMS actuator scanner 27 includes a circular mirror plate 27a. This mirror plate 27a includes a pair of axis portions 27b, 27b each extending in the radial direction. The axis portions 27b, 27b are connected to fixed portions 27d, 27d via spring portions 27c, 27c, respectively. The movable combs 27e, 27e are formed in the axis portions 27b, 27b. The movable combs 27e, 27e and the fastened combs 27fA, 27fB interdigitate. They comprise a part of a pair of right and left electrostatic actuators.

The pair of the right and left actuators is used to rotate the mirror plate 27a. Voltage V_{L} and V_{R} is applied to a pair of the fixed combs 27fA and 27fB, respectively, and the mirror plate 27a is thereby rotated in the arrow F direction.

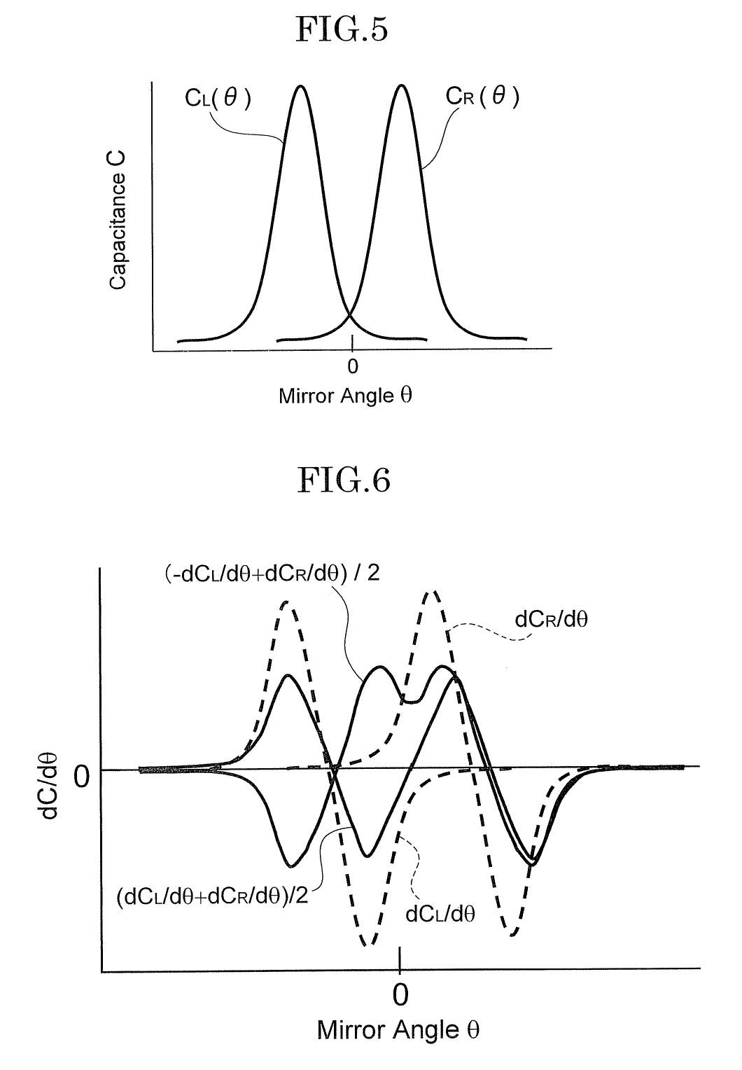

The angle dependencies of the electric capacitance on the right and left sides are defined as C_{L}(θ) and C_{R}(θ), respectively. FIG. 5 is a view illustrating the angle dependencies of the electric capacitances, C_{L}(θ) and C_{R}(θ). In FIG. 5, the horizontal axis shows the rotation angle of the mirror plate 27a and the vertical axis shows the electrostatic capacitance.

The driving torque in the equation (1) is given as follows.

$$\begin{matrix}{T}_{Total} ( θ , {V}_{L} , {V}_{R} ) = {T}_{L} ( θ , {V}_{L} ) + {T}_{R} ( θ , {V}_{R} ) & ( 2 ) \\ where {T}_{L} ( θ , {V}_{L} ) = \frac{1}{2} \frac{d {C}_{L} ( θ )}{d θ} {V}_{L}^{2} & ( 3 ) \\ {T}_{R} ( θ , {V}_{R} ) = \frac{1}{2} \frac{d {C}_{R} ( θ )}{d θ} {V}_{R}^{2} & ( 4 )\end{matrix}$$

It is now assumed that differential driving is applied by simultaneously activating both of the electrostatic actuators.

The differential operation of both of the electrostatic actuators are conducted according to the following equations (5), (6), where V_{B} is a constant bias voltage, V_{V} is a driving operation voltage, V_{L} is a differential operating voltage of the left side actuator and V_{R} is a differential operating voltage of the light side actuator.

V_{L}=V_{B}−V_{V} (5)

V_{R}=V_{B}+V_{V} (6)

It is preferable for the bias voltage V_{B} to be set to a voltage almost half of the one corresponding to a maximum driving angle.

In the case of such differential driving, the equation of motion (1) is expressed by the following equation (7).

$$\begin{matrix}I \ddot{θ} + 2 B \dot{θ} + κθ = {C}_{+}^{′} ( θ ) ( {V}_{B}^{2} + {V}_{V}^{2} ) + {C}_{-}^{′} ( θ ) ( 2 {V}_{B} {V}_{V} ) \\ where & ( 7 ) \\ {C}_{+}^{′} ( θ ) = \frac{1}{2} ( \frac{d {C}_{L} ( θ )}{d θ} + \frac{d {C}_{R} ( θ )}{d θ} ) , & ( 8 ) \\ {C}_{-}^{′} ( θ ) = \frac{1}{2} ( - \frac{d {C}_{L} ( θ )}{d θ} + \frac{d {C}_{R} ( θ )}{d θ} ) & ( 9 )\end{matrix}$$

When assuming the angle dependencies of the electric capacitances illustrated in FIG. 5, the angular dependences of the each terms (dC_{L}/dθ+dC_{R}/dθ)/2, (−dC_{L}/dθ+dC_{R}/dθ)/2, dC_{L}/dθ, dC_{R}/dθ involved in the equation (7) are given as illustrated in FIG. 6.

If the driving operation voltage V_{V} is solved from the equations (7), (8) and (9), an ideal driving waveform for a mirror angle response with respect to time is mathematically derived. The following equations (10) and (11) show the ideal driving waveforms of a driving operation voltage V_{V}.

$$\begin{matrix} when {C}_{+}^{′} \neq 0 \\ {V}_{V} ( t ) = \frac{1}{{C}_{+}^{′} ( θ )} [ - {C}_{-}^{′} ( θ ) {V}_{B} + \sqrt{\begin{matrix}- \frac{d {C}_{L} ( θ )}{d θ} \frac{d {C}_{R} ( θ )}{d θ} {V}_{B}^{2} + \\ {C}_{+}^{′} ( θ ) ( I \ddot{θ} + 2 B \dot{θ} + κθ )\end{matrix}} ] = \frac{1}{\frac{{C}_{+}^{′} ( θ )}{I}} [ - \frac{{C}_{-}^{′} ( θ )}{I} {V}_{B} + \sqrt{\begin{matrix}- ( \frac{1}{I} \frac{d {V}_{L} ( θ )}{d θ} ) ( \frac{1}{I} \frac{d {C}_{R} ( θ )}{d θ} ) {V}_{B}^{2} + \\ \frac{{C}_{+}^{′} ( θ )}{I} ( \ddot{θ} + 2 \frac{B}{I} \dot{θ} + \frac{κ}{I} θ )\end{matrix}} ] & ( 10 ) \\ when {C}_{+}^{′} ( θ ) = 0 \\ \begin{matrix} {V}_{V} ( t ) = \frac{I \ddot{θ} + 2 B \dot{θ} + κθ}{2 {C}_{-}^{′} ( θ ) {V}_{B}} \\ = \frac{\ddot{θ} + 2 \frac{B}{I} \dot{θ} + \frac{κ}{I} θ}{2 \frac{{C}_{-}^{′} ( θ )}{I} {V}_{B}}\end{matrix} & ( 11 )\end{matrix}$$

Once a desired mirror angle response θ(t) is once defined by a two times differentiable time function, the waveform V_{V}(t) of the driving operation voltage V_{V} can be uniquely obtained by using the equations (10) and (11). However, if a mirror angle response θ(t) behaves extremely rapid with time, the equations (10) or (11) may not hold.

When they do not hold, the voltage obtained from the equations (10) and (11) does not become a real number in a range suitable for driving.

Thus, when changing the angle of the mirror from θ_{A} to θ_{B}, the following equation (12), for example, can be used as the mirror angle response θ(t) to time.

$$θ ( t ) = {θ}_{A} + ( {θ}_{B} - {θ}_{A} ) \cdot \frac{1}{2} ( 1 + erf ( \frac{t}{{T}_{S}} ) ) \qquad ( 12 )$$

In this case, Ts is a time proportional to a switching time and can be arbitrarily set in a range where it does not become extremely small, and erf( ) is the error function. If the time Ts is extremely small, the equations (10), (11) may not hold.

The present invention can be applied to single side driving where an appropriate signal is applied to an actuator disposed on one side, in addition to differential driving where movable combs on both sides are differentially driven at the same time.

Next, the determination of parameters B/I, κ/I, (1/I)·dC_{L}(θ)/dθ and (1/I)·dC_{R}(θ)/dθ in the equations of the driving waveform (10) and (11) will be described.

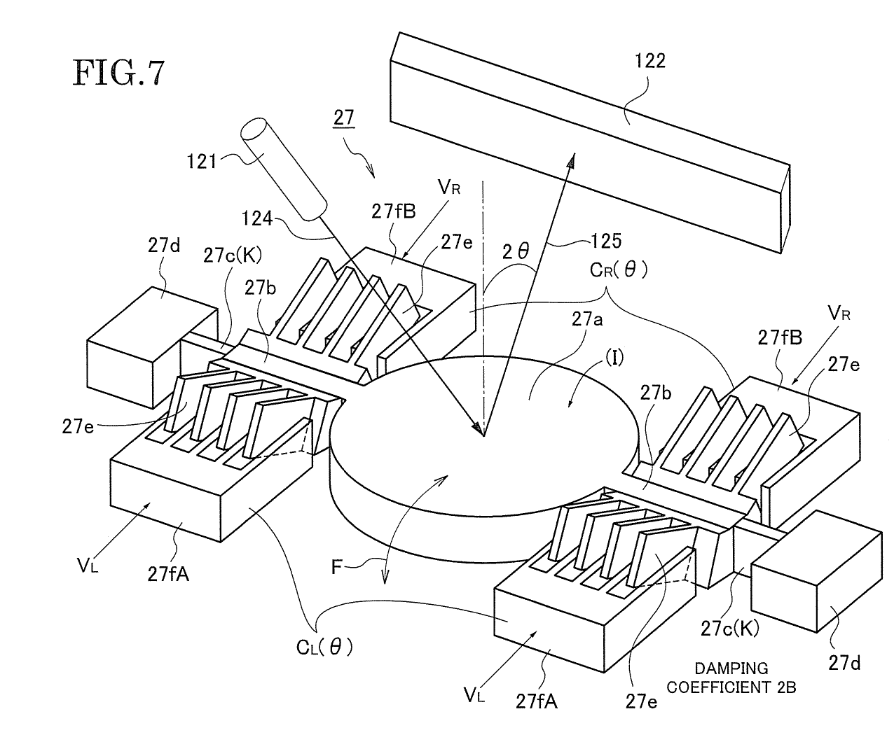

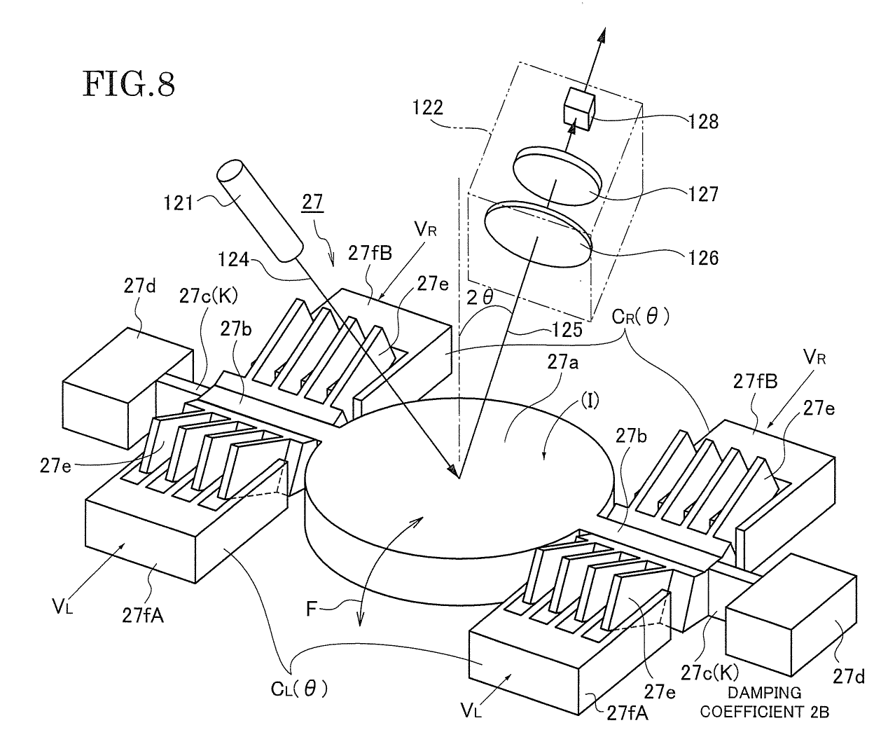

The parameters in the driving waveform are determined by using an experimental system illustrated in FIG. 7. In this experimental system, an incident light beam 124 is emitted toward a mirror plate 27a from a light source 121, the incident light beam 124 onto the mirror plate 27a is reflected and deflected by the mirror plate 27a, and a reflected and deflected beam 125 is received by a position sensitive detector (PSD) 122, so that an angle θ of the mirror plate 27a is measured. This experimental system may have a configuration where the light source 121 and the position sensitive detector 122 are disposed at optically equivalent positions created by a relay lens system. A semiconductor position sensitive detector can be used for the position sensitive detector 122. As illustrated in FIG. 8, the position sensitive detector 122 may include a structure having a gradient density filter 126, a focusing lens 127 and a photo-intensity detector 128, i.e., a structure determining a position by the intensity of received light. Moreover, the light-intensity output described pertaining to a light control device in a ranging device (Japanese Patent Application No. 2006-294219) can be used for detecting a position of light.

First, the determination of the parameters B/I and κ/I will be described.

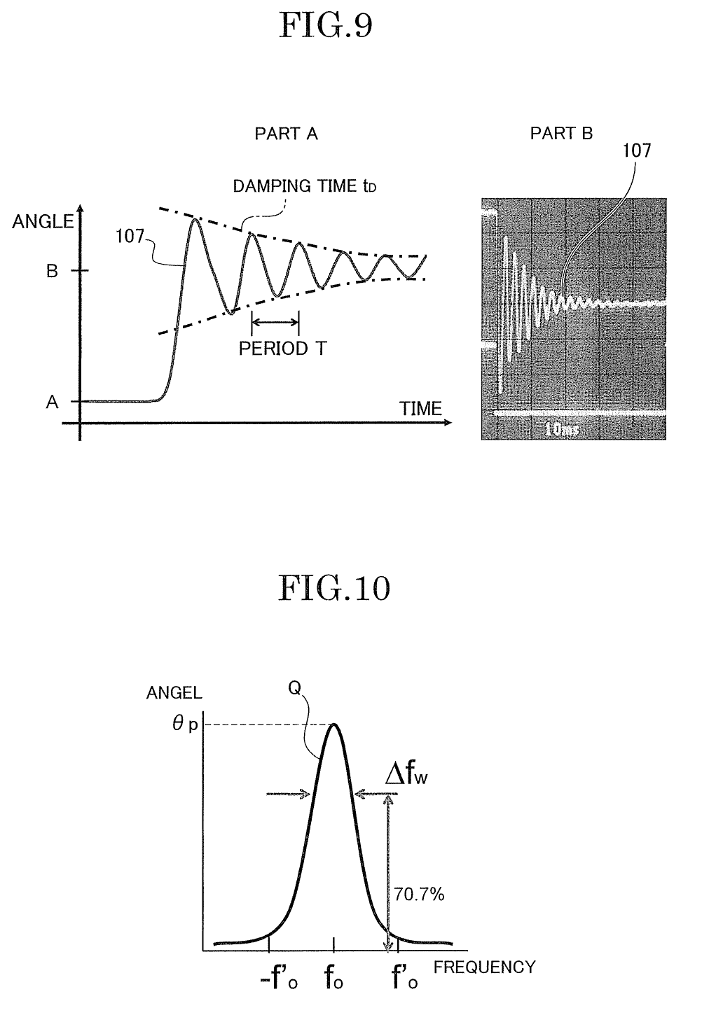

A constant voltage is applied to both or one of the right and left side actuators, so as to tilt the mirror plate 27a at a certain amount. After that, the right and left side actuators are set to 0 volt, and a transient oscillation (ringing) around a state where the driving torque is zero can be observed. If this ringing, i.e., an angle response characteristic (oscillation curve) to time of the mirror plate 27a is observed, the waveform illustrated in FIG. 9 can be obtained. In FIG. 9, Part A is a view illustrating the oscillation curve 107, and Part B is a view showing the waveform of the oscillation curve 107 actually displayed on an oscilloscope.

By using the damping of the envelope curve of this ringing waveform, a time t_{D} in which the envelope curve becomes 1/e is determined where, the symbol “e” represents the base of the natural logarithm. The parameter B/I can be obtained from the time t_{D} by using the following equation.

B/I=1/t_{D}

The period T of the ringing waveform (oscillating curve 107) is obtained by the measurement, and the parameter κ/I is obtained by the following approximate equation.

κ/I=(2π/T)²

The parameters B/I, κ/I can be more accurately obtained by the following method.

More particularly, the ringing waveform is fit to the following equation (13) representing a general damping waveform, and the parameters B/I and κ/I can be determined by using t_{D} and T_{F} obtained by the fitting and the equations B/I=1/t_{D} and κ/I=(2π/T_{F})2−(1/t_{D})2.

$$θ ( t ) = A exp ( \frac{t}{{t}_{D}} ) cos ( 2 π \frac{t}{{T}_{F}} + φ ) \qquad ( 13 )$$

In this case, the symbol A denotes an angular amplitude for the use in the fitting, and the symbol φ is a phase.

The parameters B/I, κ/I can be determined by another method.

A resonance characteristic curve Q illustrated in FIG. 10 can be obtained by determining an operation frequency and an operation amplitude (angle) of the mirror plate 27a by applying an alternating signal to both of or one of the right and left side actuators. The horizontal axis shows an oscillation frequency of the mirror plate 27a, the vertical axis shows an amplitude for a given oscillation frequency, and f₀ is a resonance frequency.

The parameter κ/I can be determined by using the following equation.

κ/I=(2 π f₀)²

The parameter B/I can be determined by using an equation, B/I=πΔf, Δf being a frequency difference between +f′₀ and −f′₀ corresponding to an operation amplitude about 1/√2 of the peak value θp.

Next, the determination of the parameters (1/I)·dC_{L}(θ)/dθ, (1/I)·dC_{R}(θ)/dθ will be described.

First, the MEMS mirror scanner 27 is driven by using either of the actuators. For example, in a state where the applied voltage V_{R} is set to 0 volt, the applied voltage V_{L} is changed, and the angle of the mirror plate 27a is measured relative to a standard angle (0 degree) when the angle of the mirror plate 27a is stabilized. This measurement of the angle uses an experimental system illustrated in FIG. 7 or a system optically equivalent to the experimental system illustrated in FIG. 7.

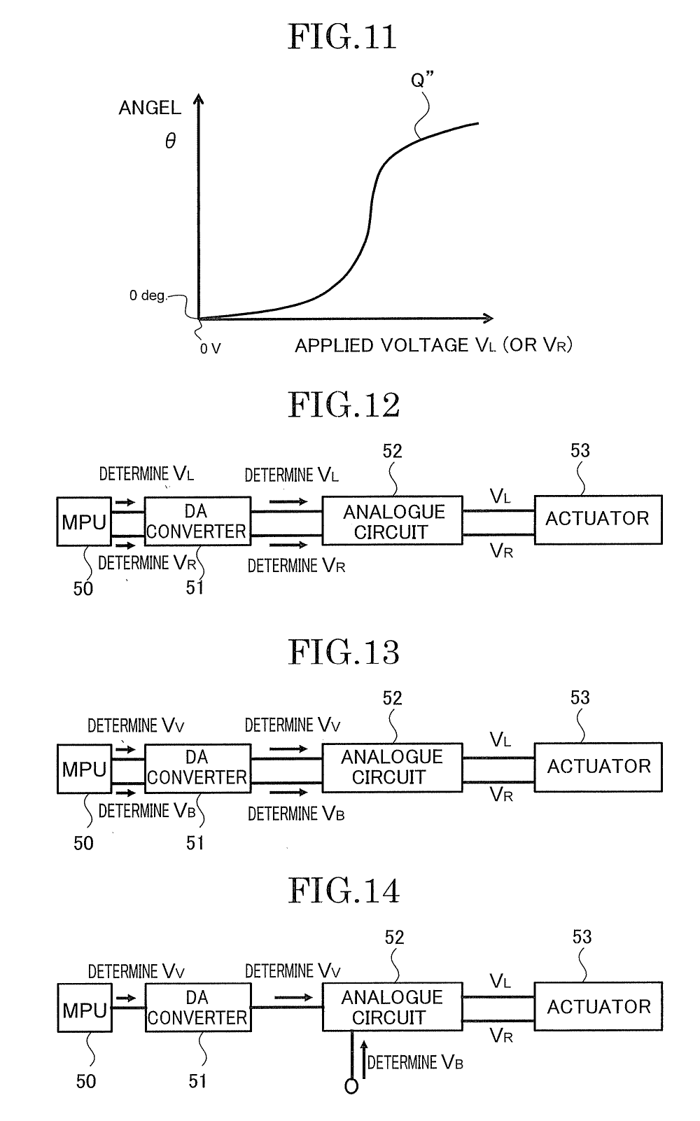

By this angle measurement, an applied voltage—angle curve Q″ is obtained, for example as shown in FIG. 11, representing a relationship between the rotation angle θ and the quasi-statically applied voltage V_{L} (or V_{R}).

This corresponds to a direct current characteristic of the rotation of the mirror plate 27a by using one of the actuators.

In this case where the angle of the mirror plate 27a is measured by setting the applied voltage V_{R} to 0 and changing the applied voltage V_{L,} the equation, κ·θ=(1/2)·{dC_{L}(θ)/dθ}·V_{L}² statically holds, so that 1/I·{dC_{L}(θ)/dθ} can be obtained by using the following equation (14).

$$\frac{1}{I} \frac{d {C}_{L} ( θ )}{d θ} = 2 \frac{κ}{I} \frac{θ}{{V}_{L}^{2}} \qquad ( 14 )$$

Similarly, if the angle of the mirror plate 27a is measured by changing the applied voltage V_{R}, where the applied voltage V_{L} is set to 0 volt, 1/I·{dC_{R}(θ)/dθ} can be obtained.

C_{L}(θ) and C_{R}(θ) can also be calculated by using numerical analyses such as a finite element method (FEM) and a boundary element method (BEM). 1/I·{dC_{L}(θ)/dθ} and 1/I·{dC_{R}(θ)/dθ} can be thereby obtained.

Next, single side driving which applies an appropriate signal to an actuator disposed on one side will be described.

If the voltage to be applied to the actuator, for example, the voltage V_{L} to be applied to the left side actuator, is set to a constant voltage or an appropriately determined time-dependent voltage change V_{B}(t), the equation of motion (1) is expressed by the following equation.

$$I \ddot{θ} + 2 B \dot{θ} + κθ = \frac{1}{2} \frac{d {C}_{L} ( θ )}{d θ} {V}_{B} ( t ) + \frac{1}{2} \frac{d {C}_{R} ( θ )}{d θ} {V}_{R} \qquad ( 15 )$$

The following equation showing an ideal driving waveform for a desired mirror angle response is obtained from the above equation (15).

$$\begin{matrix}{V}_{V} ( t ) = \sqrt{\frac{I \ddot{θ} + 2 B \dot{θ} + κθ - \frac{1}{2} \frac{d {C}_{L} ( θ )}{d θ} {V}_{B} ( t )}{\frac{1}{2} \frac{d {C}_{R} ( θ )}{d θ}}} \\ = \sqrt{\frac{\ddot{θ} + 2 \frac{B}{I} \dot{θ} + \frac{κ}{I} θ - \frac{1}{2} \frac{1}{I} \frac{d {C}_{L} ( θ )}{d θ} {V}_{B} ( t )}{\frac{1}{2} \frac{1}{I} \frac{d {C}_{R} ( θ )}{d θ}}}\end{matrix} \qquad ( 16 )$$

If a desired mirror angle response θ(t) is defined by a two times differentiable time function, a driving waveform V_{R}(t) of the voltage which should be applied to the right side actuator is obtained by V_{R}(t)=V_{V}(t) given by the above equation (16).

Accordingly, when changing an angle from θ_{A} to θ_{B}, the following equation, for example, is employed for the mirror angle response θ(t).

θ(t)=θ_{A}+(θ_{B}−θ_{A})−(1/2)·{1+erf(t/Ts)}

In this case, the time Ts proportional to the switching time can be arbitrarily set in a range where it does not become extremely small, similar to the case when driving both sides. If the Ts is extremely small, the equation may not hold, similar to the case when driving both sides.

As a special case, if the voltage V_{L} to be applied to the left side actuator is set to 0, the motion equation becomes as follows.

$$I \ddot{θ} + 2 B \dot{θ} + κθ = \frac{1}{2} \frac{d {C}_{R} ( θ )}{d θ} {V}_{R}$$

An ideal driving waveform for a desired mirror angle response becomes as follows.

$$\begin{matrix}{V}_{R} = \sqrt{\frac{I \ddot{θ} + 2 B \dot{θ} + κθ}{\frac{1}{2} \frac{d {C}_{R} ( θ )}{d θ}}} \\ = \sqrt{\frac{\ddot{θ} + 2 \frac{B}{I} \dot{θ} + \frac{κ}{I} θ}{\frac{1}{2} \frac{1}{I} \frac{d {C}_{R} ( θ )}{d θ}}}\end{matrix}$$

In this case, the driving waveform V_{R}(t)=V_{V}(t) is obtained by setting the voltage V_{L} to be applied to the left side actuator to a constant voltage or an appropriately determined time-dependent voltage V_{B}(t), for the sake of simplicity of description. Alternatively, the driving waveform V_{L}(t)=V_{V}(t) to be applied to the left side actuator can be obtained by setting the voltage V_{R} to be applied to the right side actuator to a constant voltage or an appropriately determined time-dependent voltage V_{B}(t).

A block circuit of an electric driving system for the use in these experiments is illustrated in FIG. 12.

Referring to FIG. 12, reference number 50 denotes a microprocessor unit (MPU), 51 denotes a digital analogue converter (DA converter), 52 denotes an analogue circuit, and 53 denotes an actuator. The digital applied voltage V_{L} and V_{R} is determined by the microprocessor unit (MPU) 50, and the digital applied voltage V_{L} and V_{R} is converted into analogue applied voltage V_{L} and V_{R} by the digital analogue converter 51. The analogue applied voltage V_{L} and V_{R} is output to the respective actuators by the analogue circuit 52, and the actuator 53 is thereby rotated by a predetermined angle.

Moreover, in the case of a block circuit of an electric driving system illustrated in FIG. 13, the digital driving operation voltage V_{V} and the digital bias voltage V_{B} are determined by the microprocessor unit (MPU) 50, the digital driving operation voltage V_{V} and the digital bias voltage V_{B} are converted into the analogue driving operation voltage V_{V} and the analogue bias voltage V_{B} by the digital analogue converter 51, and differential voltages V_{L}=V_{B}−V_{V} and V_{R}=V_{B}+V_{V} for differentially driving both actuators may be generated from the analogue driving operation voltage V_{V} and the analogue bias voltage V_{B} by the analogue circuit 52. The differential voltage is output to the respective actuators. The actuator 53 is thereby rotated by a predetermined angle.

Furthermore, as illustrated in FIG. 14, the microprocessor unit 50 may output the digital driving operation voltage V_{V} to the digital analogue converter 51, and the digital analogue converter 51 may output the analogue driving operation voltage V_{V} to the analogue circuit 52. The analogue circuit 52 may generate differential voltages V_{L}=V_{B}−V_{V} and V_{R}=V_{B}+V_{V} incorporating the bias voltage V_{B} for differentially driving both actuators and output the differential voltage to the actuator. The actuator 53 can be thereby rotated by a predetermined angle.

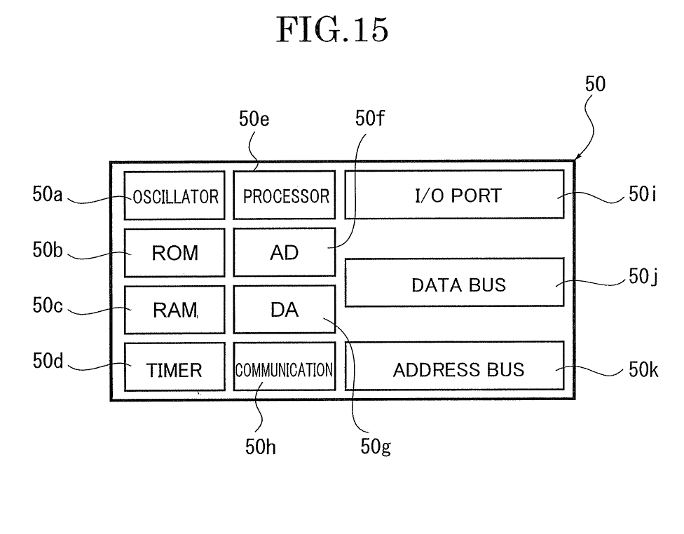

A composition illustrated in FIG. 15 may, for example, be employed as a microprocessor unit 50. The microprocessor unit 50 illustrated in FIG. 15 includes an oscillator 50a, a ROM memory 50b, a RAM memory 50c, a timer 50d, a central processing unit (processor) 50e, an AD converter 50f, a DA converter 50g, a communication device 50h, an input and output port 50i, a data bus 50j and an address bus 50k. When using the DA converter 50g built in the microprocessor unit 50, the DA converter 51 illustrated in FIG. 12-14 may be omitted. In order to reduce internal digital processing loaded on the microprocessor 50, an interface such as FPGA (field-programmable gate array) may be disposed between the DA converter 51 and the microprocessor unit 50 illustrated in FIG. 12-14. A memory may be provided not only inside the microprocessor unit 50 but also outside the microprocessor unit 50.

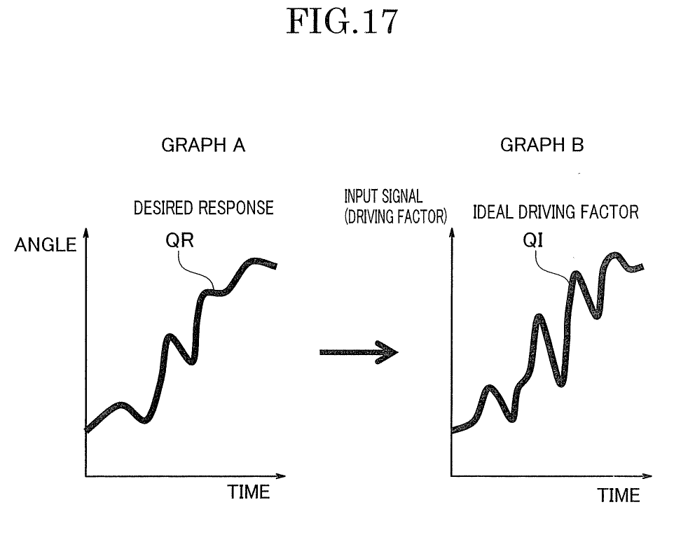

According to the present invention, an appropriate input signal QI as illustrated in Graph B in FIG. 17 can be obtained as a function of time for a desired mirror angle response characteristic QR required by each specific application as illustrated in Graph A in FIG. 17.

In the meantime, it is preferable for θ(t) to be two times differentiable with respect to time.

For example, a continuous function θ(t) given by the following equation is one time differentiable but not two times differentiable with respect to time.

$$θ ( t ) = \{ \begin{matrix}{θ}_{A} & t < - 2 Ts \\ {θ}_{A} + \frac{1}{2} \cdot ( {θ}_{B} - {θ}_{A} ) \cdot \{ 1 + sin ( \frac{π}{2} \cdot \frac{t}{2 Ts} ) \} & - 2 Ts < t < 2 Ts \\ {θ}_{B} & t > 2 Ts\end{matrix} \}$$

In this case, θ(t) is not two times differentiable only at two points, t=±2Ts, and it is possible to define a voltage driving waveform which is not continuous only at the above two points.

The discontinuous nature of the voltage driving waveform at the two points means that the voltage has to change at an infinite speed at each of the two points. However, it is impossible that the voltage actually generated from an electric driving system changes at an infinite speed. Therefore, it becomes difficult to accurately replicate the voltage driving waveform determined as described above.

On the other hand, the function defined by the equation (12), for example, is two times differentiable with respect to time. In this case, θ(t) is sufficiently smooth, the required voltage driving waveform is continuous and the rate of the voltage change is not infinite. For this reason, an electric driving system can sufficiently and accurately apply the voltage driving waveform to the MEMS actuator. Therefore, a desired θ(t) can be accurately satisfied.

As described above, according to the MEMS mirror scanner, the MEMS actuator scanner, and the method of controlling the rotation angle of the MEMS actuator, a desired angle response characteristic to time can be obtained, so that high-speed switching of an optical path and vector drawing is facilitated. By obtaining a desired mirror angle response characteristic to time, the oscillation of the MEMS mirror scanner and the MEMS actuator scanner can be accurately damped to a resting state, the driving scheme can be simplified without using a large capacity memory, the parameters can be quickly determined, and the degree of freedom in the driving can be sufficiently secured.

Although the present invention has been described in terms of exemplary embodiments, it is not limited thereto. It should be appreciated that variations may be made in the embodiments described by persons skilled in the art without departing from the scope of the present invention as defined by the following claims.

1. A method of driving a MEMS mirror scanner including an electrostatic actuator, comprising a step of driving the electrostatic actuator according to an input signal in accordance with a driving waveform obtained by the following equation,
$$when {C}_{+}^{′} ( θ ) \neq 0$$
$${V}_{V} ( t ) = \frac{1}{\frac{{C}_{+}^{′} ( θ )}{I}} [ - \frac{{C}_{-}^{′} ( θ )}{I} {V}_{B} + \sqrt{\begin{matrix}- ( \frac{1}{I} \frac{d {C}_{L} ( θ )}{d θ} ) ( \frac{1}{I} \frac{d {C}_{R} ( θ )}{d θ} ) {V}_{B}^{2} + \\ \frac{{C}_{+}^{′} ( θ )}{I} ( \ddot{θ} + 2 \frac{B}{I} \dot{θ} + \frac{κ}{I} θ )\end{matrix}} ]$$
$$when {C}_{+}^{′} ( θ ) = 0 \\ {V}_{V} ( t ) = \frac{\ddot{θ} + 2 \frac{B}{I} \dot{θ} + \frac{κ}{I} θ}{2 \frac{{C}_{-}^{′} ( θ )}{I} {V}_{B}}$$
where B/I, κ/I, (1/I)·dC_{L}(θ)/dθ and (1/I)·dC_{R}(θ)/dθ are parameters to obtain the driving waveform, θ(t) is a desired mirror angle response, I is a moment of inertia of an moving part including a mirror, 2B is a damping factor (damping coefficient), κ is a spring constant, C_{L}(θ), C_{R}(θ) are angle dependencies of an electric capacitance, V_{B} is a constant bias voltage in differential driving, and C₊′(θ) and C₋′(θ) are ½ of the sum and the difference of the first order derivative of C_{L}(θ) and C_{R}(θ) with respect to θ, respectively, which are represented by the following equations,
$$\begin{matrix}{C}_{+}^{′} ( θ ) = \frac{1}{2} ( \frac{d {C}_{L} ( θ )}{d θ} + \frac{d {C}_{R} ( θ )}{d θ} ) , & ( 8 ) \\ {C}_{-}^{′} ( θ ) = \frac{1}{2} ( - \frac{d {C}_{L} ( θ )}{d θ} + \frac{d {C}_{R} ( θ )}{d θ} ) & ( 9 )\end{matrix}$$

2. A method of driving a MEMS mirror scanner including an electrostatic actuator, comprising a step of driving the electrostatic actuator according to an input signal in accordance with a driving waveform obtained by the following equation,
$${V}_{V} ( t ) = \sqrt{\frac{\ddot{θ} + 2 \frac{B}{I} \dot{θ} + \frac{κ}{I} θ - \frac{1}{2} \frac{1}{I} \frac{d {C}_{L} ( θ )}{d θ} {V}_{B} ( t )}{\frac{1}{2} \frac{1}{I} \frac{d {C}_{R} ( θ )}{d θ}}}$$
where, B/I, κ/I, (1/I)·dC_{L}(θ)/dθ and (1/I)·dC_{R}(θ)/dθ are parameters for obtaining the driving waveform, θ(t) is a desired mirror angle response, I is a moment of inertia of a moving part including a mirror, 2B is a damping factor (damping coefficient), κ is a spring constant, C_{L}(θ) and C_{R}(θ) are angle dependencies of an electric capacitance, V_{B}(t) is a constant bias voltage or an appropriately determined time-dependent voltage change in single side driving, and C₊′(θ) and C₋′(θ) are ½ of the sum and the difference of the first order derivative of C_{L}(θ) and C_{R}(θ) with respect to θ, respectively, which are represented by the following equations,
$$\begin{matrix}{C}_{+}^{′} ( θ ) = \frac{1}{2} ( \frac{d {C}_{L} ( θ )}{d θ} + \frac{d {C}_{R} ( θ )}{d θ} ) , & ( 8 ) \\ {C}_{\_}^{′} ( θ ) = \frac{1}{2} ( - \frac{d {C}_{L} ( θ )}{d θ} + \frac{d {C}_{R} ( θ )}{d θ} ) & ( 9 )\end{matrix}$$

3. The method of driving a MEMS mirror scanner according to claim 1, wherein at least one of the parameters is experimentally determined.

4. The method of driving a MEMS mirror scanner according to claim 1, wherein θ(t) is two times differentiable with respect to time.

5. A method of driving a MEMS actuator scanner, comprising steps of:
defining an actuation of the MEMS actuator as a function of time;
determining by an experiment or calculation terms included in the equation of motion governing motion of the MEMS actuator except a variable representing the actuation, derivatives thereof with respect to time and a variable corresponding to an input signal; and
determining the input signal by substituting to the equation of motion the actuation of the MEMS actuator as the function of a time and the terms in the equation of motion except the variable representing the actuation, the derivatives thereof with respect to time and the variable corresponding to the input signal.

6. The method of driving a MEMS actuator scanner according to claim 5, wherein the variable representing the actuation is two times differentiable with respect to time.

7. The method of driving a MEMS actuator scanner according to claim 5, wherein
the MEMS actuator includes an electrostatically-driven comb structure, the variable representing the actuation in the equation of motion governing motion of the MEMS actuator is a displacement or a rotation angle,
the variable corresponding to the input signal is voltage, and
the terms in the equation of motion governing motion of the MEMS actuator except the variable representing the actuation, the derivatives thereof with respect to time and the variable corresponding to the input signal are an inertia term, a damping term, an elastic term and a first order derivative of the electric capacitance of the comb structure with respect to the displacement or the rotation angle.

8. The method of driving a MEMS actuator scanner according to claim 7, wherein the damping term is determined by measuring a transient damping oscillation around a state where applied voltage to the MEMS actuator is 0.

9. The method of driving a MEMS actuator scanner according to claim 7, wherein the elastic term is determined by measuring a transient damping oscillation around a state where applied voltage to the MEMS actuator is 0.

10. The method of driving a MEMS actuator scanner according to claim 7, wherein the damping term is determined by measuring a resonance characteristic of the MEMS actuator.

11. The method of driving a MEMS actuator scanner according to claim 7, wherein the elastic term is determined by measuring a resonance characteristic of the MEMS actuator.

12. The method of driving a MEMS actuator scanner according to claim 7, wherein the first order derivative of the electric capacitance of the comb structure with respect to the displacement or the rotation angle is determined by measuring a relationship between quasi-statically applied voltage and the displacement or the rotation angle of the actuator.

13. A method of controlling a rotation angle of a MEMS actuator having a comb structure, which is driven by voltage, comprising steps of:
defining a rotation angle of the MEMS actuator as a function of time;
determining by an experiment or calculation terms included in the equation of motion governing the rotation except the rotation angle, derivatives thereof with respect to time and the voltage; and
determining the voltage by substituting to the equation of motion the rotation angle and the terms in the equation of motion except the rotation angle, the derivatives thereof with respect to time and the voltage.

14. The method of controlling a rotation angle of a MEMS actuator according to claim 13, wherein the rotation angle of the MEMS actuator is two times differentiable with respect to time.

15. The method of controlling a rotation angle of a MEMS actuator having a comb structure according to claim 13, wherein the terms in the equation of motion governing the rotation of the MEMS actuator except the rotation angle, the derivatives thereof with respect to time and the voltage are an inertia term, a damping term, an elastic term and a first order derivative of an electric capacitance of the comb structure with respect to the rotation angle.

16. The method of controlling a rotation angle a MEMS actuator according to claim 15, wherein the damping term is determined by measuring a transient damping oscillation around a state where applied voltage to the MEMS actuator is 0.

17. The method of controlling a rotation angle of a MEMS actuator according to claim 15, wherein the elastic term is determined by measuring a transient damping oscillation around a state where applied voltage to the MEMS actuator is 0.

18. The method of controlling a rotation angle of a MEMS actuator according to claim 15, wherein the damping term is determined by measuring a resonance characteristic of the MEMS actuator.

19. The method of controlling a rotation angle of a MEMS actuator according to claim 15, wherein the elastic term is determined by measuring a resonance characteristic of the MEMS actuator.

20. The method of controlling a rotation angle of a MEMS actuator according to claim 15, wherein the first order derivative of the electric capacitance of the comb structure with respect to the rotation angle is determined by measuring a relationship between quasi-statically applied voltage and the rotation angle of the MEMS actuator.

21. The method of driving a MEMS mirror scanner according to claim 2, wherein at least one of the parameters is experimentally determined.

22. The method of driving a MEMS mirror scanner according to claim 2, wherein θ(t) is two times differentiable with respect to time.
